(19) United States
(12) Patent Application Publication
(10) Pub. No.: US 2007/0157531 A1
(43) Pub. Date: Jul. 12, 2007

(54) Critter stopper

(76) Inventor: Malcolm A. Whitaker, Venice, FL (US)

Correspondence Address: MALCOLM A. WHITAKER, 222 VENICE PALMS BLVD., VENICE, FL, 34292, US

(21) Appl. No.: 11/311,880

(22) Filed: Dec. 20, 2005

(51) Int. Cl. E04B 1/72; A01K 3/00; E04H 9/16

(52) U.S. Cl. 52/101

(57) ABSTRACT

A perforated tube made of plastic with a cap on one end and several different size nipples on the other end becomes a potential critter stopper. The invention attaches to condensate drains from central air-conditioning units at the exterior of the building. The invention can also be used on exit drains from swimming pool overflow piping, and on perimeter floor drain gutter systems in screened in lanais. The invention allows the water to exit normally and prohibits the critters from entering the dwelling or clogging up the piping. The invention attaches easily, by friction fit, therefore allowing it to be removed at some point to be flushed out and cleaned. The cap is friction fit also to permit removal and cleaning.

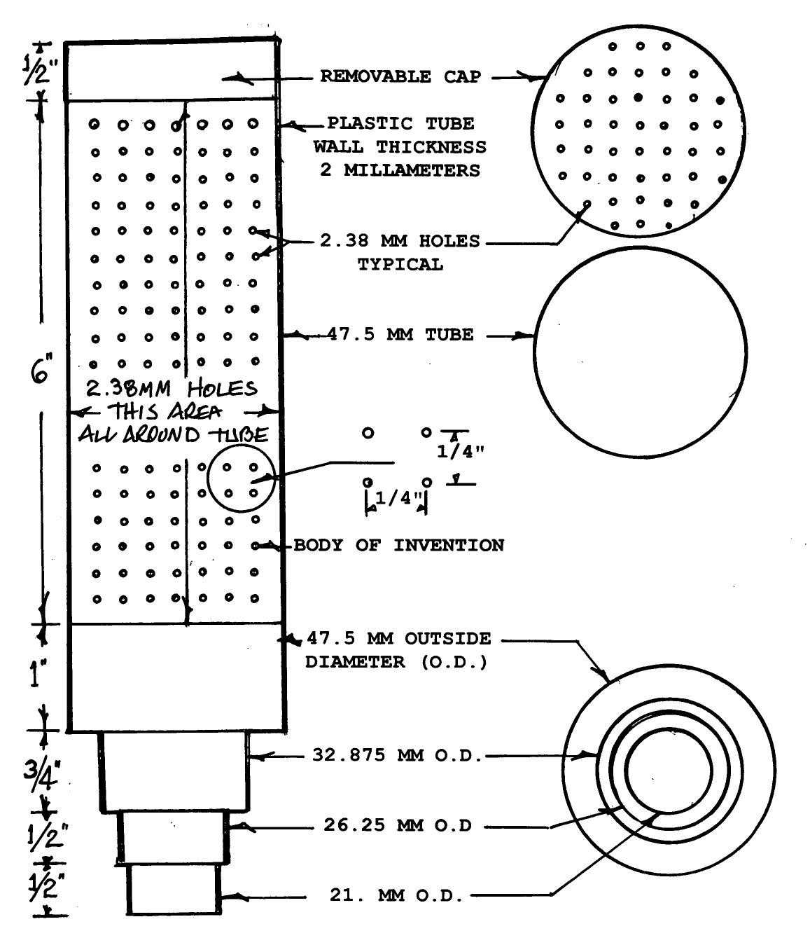

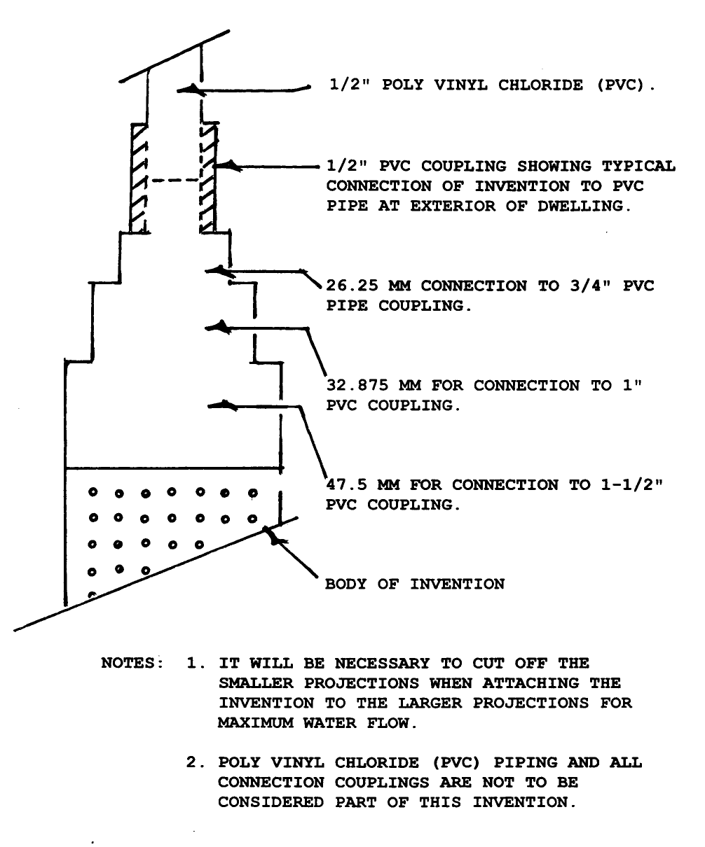

A portion of the disclosure of this document may contain Material which is subject to {copyright or mask work) protection. The (copyright or mask work} owner has no objection to the facsimile reproduction by anyone of the patent document or the disclosure, as it appears in the Patent and Trademark Office patent file or records, but otherwise reserves all {copyright or mask work} rights whatsoever.

### BACKGROUND OF THE INVENTION

The need for a device to prohibit small critters, snakes geckos, roaches, frogs, toads etc., from entering the residence through air conditioner condensate drains and other small discharge drains.

### BRIEF SUMMARY OF THE INVENTION

A device that when attached to the existing Poly Vinyl Chloride (PVC) discharge drain piping at the exterior of the dwelling, allows water to exit normally without allowing little creatures to enter the orifice.

### DESCRIPTION OF THE DRAWINGS

Drawing 1/2 shows a tube like device with cap on one end and 6. a series of smaller diameter tube like projections on the other end for connecting to various size piping. The drawing shows a 6″ long section of the tube with 2.38 millameter holes totally around the circumference at one quarter inch intervals both ways. The removable cap also has similar perforations.

Drawing 2/2 shows typical connections to Poly Vinyl Chloride (PVC) piping by friction fit into an existing one half inch pipe protruding to the exterior of the house wall. This device, as shown, can be attached to larger size piping, up to one inch and a half, by simply cutting off the smaller unused protrusions and inserting into coupling.

### DETAILED DESCRIPTION OF THE INVENTION

The device, CRITTER STOPPER, when installed on unprotected open ended Poly Vinyl Chloride piping that vents or discharges to the outside of the residence, such as condensate piping from the air-conditioner, perimeter floor gutter drain systems in screened in lanais, swimming pool water lowering conduits and most other small protuberances can significantly deter the entrance of snakes, frogs, toads, roaches, geckos and many other CRITTERS. The CRITTER STOPPER is a 47.5 mm plastic tube, 232 mm in length, with 2.38 mm holes completely around the circumference and on the cap end, spaced at quarter inch intervals. These holes permit the uninterrupted flow of water without allowing the critters to enter the dwelling.

The cap as well as the entire unit can be quickly removed and flushed with a hose to remove any sediment that might occur within the device. Installation of the CRITTER STOPPER is easily installed to standard Poly Vinyl Chloride pipe fittings and can be orientated either horizontally or vertically as the situation warrants.

1. I claim the invention, as submitted herewith, to be solely that of my own creation, and being of sane and sound mind, present these drawings, documents, and application papers with all due respect, honesty, and sincerety, claiming and acknowledging this as my own innovation.
